(19) United States
(12) Patent Application Publication
(10) Pub. No.: US 2025/0238012 A1
(43) Pub. Date: Jul. 24, 2025

(54) MANAGING MACHINING INFORMATION, FOR EXAMPLE DETERMINING STEP FEATURES FROM A SAMPLE MACHINING PROCESS, METHOD, COMPUTER SYSTEM AND MACHINE TOOL

(71) Applicant: Siemens Industry Software Inc., Plano, TX (US)

(72) Inventors: Reinier Capelle, Hengelo (NL); Alex Stienstra, Enschede (NL); Arto Saari, Losser (NL)

(21) Appl. No.: 18/856,169

(22) PCT Filed: Apr. 13, 2022
(86) PCT No.: PCT/IB2022/053469

§ 371 Date: Oct. 11, 2024

(51) Int. Cl. G05B 19/4063

(52) U.S. Cl. CPC G05B 19/4063; G05B 2219/35012; G05B 2219/42256

(57) ABSTRACT

For an improved management of machining information, esp. for a facilitated determination of step features from a sample machining process, a computer-implemented method is suggested comprising: providing a sample machining process for machining a sample workpiece from a sample blank, the sample machining process comprising at least two consecutive sample machining steps performed by the respective tool starting with a respective sample start part and ending with a respective sample end part, wherein the respective sample end part of the respective sample machining step is the respective sample start part of the respective subsequent sample machining step; determining a respective step tool volume corresponding to a movement of the respective tool during the respective sample machining step; determining a respective step volume corresponding to the respective sample start part of the respective sample machining step changed by the respective step tool volume; determining at least one respective step feature corresponding to the respective step volume; and storing the respective step feature in a machining information database.

### CROSS REFERENCE TO RELATED APPLICATIONS

This present patent document is a § 371 nationalization of PCT Application Serial Number PCT/IB2022/053469, filed Apr. 13, 2022, designating the United States which is hereby incorporated in its entirety by reference.

### FIELD

Embodiments are directed to machining where materials, e.g., extremely hard materials, have to be machined, e.g., by milling, turning, cutting, boring, grinding, shearing, or other forms of deformation including additive manufacturing. For such purposes, machine tools are used, whereby such machine tools are generally controlled numerically by a control device or processor, whereby software solutions for computer-aided design/manufacturing/engineering (CAD/CAM/CAE) are used to support or control the machining process, and whereby manufacturing rules may be used as abstract descriptions that may be instantiated into actual machining operations (collectively referred to herein as product systems).

### BACKGROUND

Machine tools, such as lathes, milling machines, etc., are widely used to machine workpieces. Generally, such machine tools include a tool for machining the workpiece and are numerically controlled by a control device. Machining a workpiece regularly involves comprehensive and time-consuming preparatory steps to ensure a good quality of the machined workpiece, to avoid an excessive tool wear, and to ensure efficiency with respect to time and costs. For example, manufacturing rules including step features for the individual machining steps may need to be defined or derived before these manufacturing rules may actually be to derive actual machining operations for a given designed workpiece.

Currently, there exist product systems and solutions that support managing machining information. Such product systems may benefit from improvements.

U.S. Pat. No. 6,047,225 A discloses an automatic programming apparatus including a machining unit preparing section for preparing plural machining units, a machining unit defining section for selecting a designated machining unit from the prepared machining units and designating the arrangement and size of the machining area of the selected machining unit, and an machined material creating section for creating a shape with the machining area shape removed from the material shape. The automatic programming apparatus and method for an NC machine that may easily create a machining program in complicated machining and also create a correct program quickly in complicated machining by trial and error.

U.S. Pat. No. 10,466,681 B1 discloses systems and methods for machining knowledge reuse by determining a machining strategy for a designated part to be formed, based at least in part on machining strategy information used to form one or more similar parts. Methods include receiving an input representation (such as a 3D model) of the designated part, searching a machining knowledge database for one or more similar parts that have a shape similar to the designated part, retrieving machining strategy information that was used to form the similar parts, and deriving a machining strategy for the designated part based at least in part on the machining strategy information used to form the similar parts.

US 2021/278822 A1 discloses systems, devices, and methods including selecting one or more sequences of machining types for a feature of one or more features, where the selection of the one or more sequences of machining types is based on the feature and a database of prior selections of machining types; selecting one or more tools for the selected one or more sequences of machining types, where the selection of the one or more tools is based on the feature, the selected one or more sequences of machining types, and a database of prior selections of one or more tools; and selecting one or more machining parameters for the selected one or more tools, where the selected machining parameters are based on the feature, the selected one or more sequences of machining types, the selected one or more tools, and a database of prior selections of one or more machining parameters.

### BRIEF SUMMARY AND DESCRIPTION

The scope of the embodiments is defined solely by the appended claims and is not affected to any degree by the statements within this summary. The present embodiments may obviate one or more of the drawbacks or limitations in the related art.

Variously disclosed embodiments include machining information methods, computer systems, and machine tools that may be used to facilitate managing a postprocessor, for example determining step features from a sample machining process.

According to a first aspect, a computer-implemented method managing machining information for machining a workpiece with a respective tool that is included by a machine tool is provided, wherein the method may include: providing a sample machining process for machining a sample workpiece from a sample blank, the sample machining process including at least two consecutive sample machining steps performed by the respective tool starting with a respective sample start part and ending with a respective sample end part, wherein the respective sample end part of the respective sample machining step is the respective sample start part of the respective subsequent sample machining step; determining a respective step tool volume corresponding to a movement of the respective tool during the respective sample machining step, wherein the respective step tool volume corresponds to the difference in volume between the respective sample start part and the respective sample end part obtained through the respective sample machining step; determining a respective step volume corresponding to the respective sample start part of the respective sample machining step changed by the respective step tool volume; determining at least one respective step feature corresponding to the respective step volume; and storing the respective step feature in a machining information database.

According to a second aspect, a computer system may be arranged and configured to carry out the steps of this computer-implemented method of managing machining information, for example determining step features from a sample machining process. By way of example, the computer system may be a computer-aided manufacturing system or a control device for numerically controlling a machine tool that includes a tool for machining a workpiece according to a machining process.

According to a third aspect, a machine tool may include a tool for machining a workpiece according to a machining process and this control device for numerically controlling the machine tool.

According to a fourth aspect, a computer program product may include computer program code that, when executed by a computer system, causes the computer system to carry out the steps of this computer-implemented method of managing machining information, for example determining step features from a sample machining process.

According to a fifth aspect, a computer-readable medium may include computer program code that, when executed by a computer system, causes the computer system to carry out the steps of this computer-implemented method of managing machining information, for example determining step features from a sample machining process. By way of example, the described computer-readable medium may be non-transitory and may further be a software component on a storage device.

### BRIEF DESCRIPTION OF THE DRAWINGS

FIGS. 1-4 depict a functional block diagram of an example product system that facilitates managing machining information, for example determining step features from a sample machining process, respectively according to an embodiment.

FIGS. 5-7 depict flow diagrams of an example methodology that facilitates managing machining information, for example determining step features from a sample machining process, and sample step features, in a product system according to an embodiment.

FIGS. 8-10 depict some sample rules relating to some determined sample step features, in a product system, respectively according to an embodiment.

FIG. 11 depicts a flow diagram of an example methodology that facilitates managing machining information, for example determining step features from a sample machining process, in a product system according to an embodiment.

FIG. 12 depicts a block diagram of a data processing system according to an embodiment.

### DETAILED DESCRIPTION

Various technologies that pertain to systems and methods for managing a postprocessor, for example determining a new postprocessor, in a product system will now be described with reference to the drawings, where like reference numerals represent like elements throughout. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements.

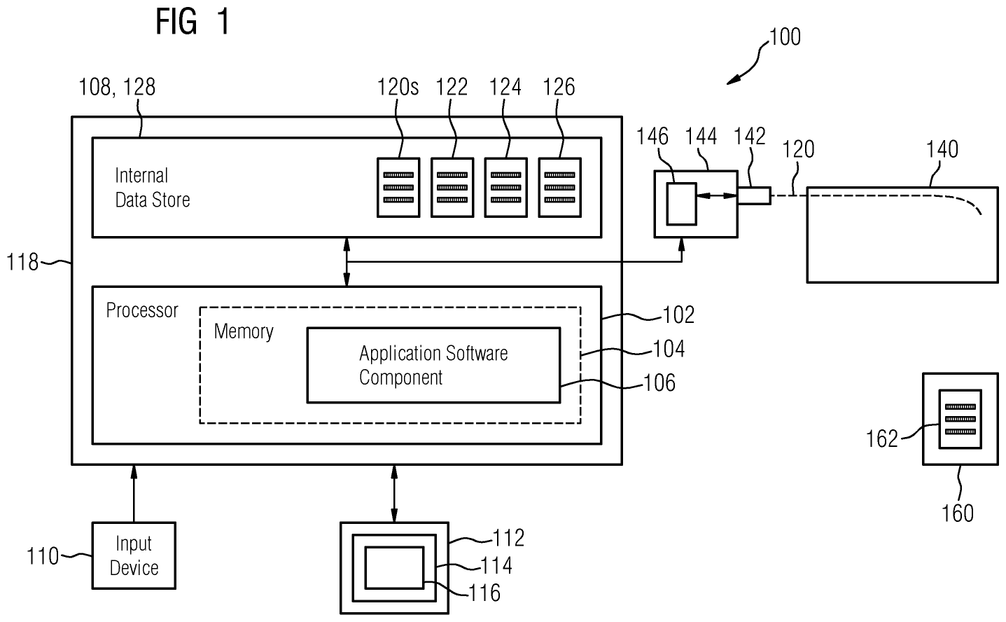

With reference to FIG. 1, a functional block diagram of an example product system or data processing system 100 is depicted that facilitates managing machining information, for example determining step features 126 from a sample machining process 120s. The processing system 100 may include a computer-aided manufacturing (CAM) system 118 or another software system, such as a design-aided design (CAD) system, a computer-aided engineering (CAE) system, a product lifecycle management (PLM) system or a manufacturing operations management (MOM) system. In some examples, the software system 118 may be or be included by a machine tool 144.

Examples of CAM systems that may be adapted to include some of the features described herein may include the NX suite of applications or Solid Edge applications produced by Siemens Industry Software Inc., of Plano, Texas, USA. Other CAM systems, e.g., of Dassault Systèmes SE, of Vélizy-villacoublay, France, may have similar functionalities.

The processing system 100 may include at least one processor 102 that is configured to execute at least one application software component 106 from a memory 104 accessed by the processor 102. The application software component 106 may be configured (i.e., programmed) to cause the processor 102 to carry out various acts and functions described herein. For example, the described application software component 106 may include and/or correspond to one or more components of a computer-aided manufacturing software application and/or a machine tool control software application that is configured to generate and store product data in a data store 108 or a machining information database 128, such as a database respectively.

To enable the enhanced management machining information, for example determining step features 126 from a sample machining process 120s, the described product system or data processing system 100 may include at least one input device 110 and at least one display device 112 (such as a display screen). The described processor 102 may be configured to generate a GUI 114 through the display device 112. Such a GUI 114 may include GUI elements such as buttons, links, search boxes, lists, text boxes, images, scroll bars usable by a user to provide inputs through the input device 110 that cause managing machining information, for example determining step features 126 from a sample machining process 120s. The input device 110 and/or the display device 112 may be included by the CAM system 118 or be included by the machine tool 144.

For the facilitated management machining information, for example determining step features 126 from a sample machining process 120s, the machine tool 144 may include a tool 142 for machining the workpiece 140 according to a machining process 120. The tool 142 may be numerically controlled by the processor 102, the machine tool 144 or preferably a control device 146 that may be included by the machine tool 144. Herein, machining may include among others processes during which a material, often a metal, is cut into a desired final shape and size by a controlled material-removal process. The processes that have this common theme, namely controlled material removal, are today collectively known as subtractive manufacturing and may include milling or turning. In the context of the present document, machining may further include additive manufacturing processes, i.e., processes of controlled material addition. The tool 142 may then add (layers of) material to the workpiece 140.

In an example embodiment, the application software component 106 and/or the processor 102 may be configured to provide a sample machining process 120s for machining a sample workpiece 140s from a sample blank 148s, the sample machining process 120s including at least two consecutive sample machining steps 120s-i performed by the respective tool 142-i starting with a respective sample start part lwf-i and ending with a respective sample end part mwf-i. The respective sample end part mwf-i of the respective sample machining step 120s-i is the respective sample start part lwf-i+1 of the respective subsequent sample machining step 120s-i+1.

By way of example, the sample machining process 120s may include two or more sample machining steps 120s-i, e.g., a first drilling step 120s-1 performed with a drilling tool 142-1 and then the second milling step 120s-2 performed with a milling tool 142-2. Hereby, the sample start part lwf-1 of the drilling step 120s-1 may be the sample blank 148s, the sample end part mwf-1 of the drilling step 120s-1 may be the drilled sample blank 148s, wherein the sample start part lwf-2 of the milling step 120s-2 is the sample end part mwf-1 of the drilling step 120s-1, and whereby the sample end part mwf-2 of the milling step 120s-2 may then be the completely machined sample workpiece 140s that is the drilled and milled sample blank 148s. It is understood that, in some more advanced or complex examples, there may be one or more intermediate machining steps 120-i. Hereby, the terms “less-worked feature” and “more-worked feature” with respect to a certain machining step 120-i may sometimes be used in a CAM or machining context, hence the notations “lwf” and “mwf”.

In some examples, the respective sample workpiece 140s and the corresponding respective sample machining process 120s may be available since they have previously been designed or engineered by the user or the CAM system 118 or the machine tool 144. In further examples, the respective sample workpiece 140s and the corresponding respective sample machining process 120s may be available in the machining information database 128 that may, e.g., be provided by the maker of the CAM system 118 or the machine tool 144 or that may be a sort of knowledge database that may be used by the user for training purposes or the like. Further, the respective sample start part lwf-i and/or the respective sample end part mwf-i may, in some examples, be understood as solid models. Such examples of sample workpieces 140s and corresponding machining processes 120s may serve as a starting point for the suggested approach to derive step features 126 that may be stored in the machining information database 128 to serve as a step feature knowledge base for later machining processes 120.

In some examples, the application software component 106 and/or the processor 102 may further be configured to determine a respective step tool volume 122-i corresponding to a movement of the respective tool 142-i during the respective sample machining step 120s-i.

During the respective sample machining step 120s-i, the respective tool 142-i used for this respective sample machining step 120s-i may make a movement to machine the respective sample start part lwf-i to obtain the respective sample end part mwf-i. The movement of the respective tool 142-i during the respective sample machining step 120s-i or, e.g., the difference between the respective sample start part lwf-i and the respective sample end part mwf-i, may correspond to the respective step tool volume 122-i. Hence, the respective step tool volume 122-i may, e.g., be understood as the difference in volume between the respective sample start part lwf-i and the respective sample end part mwf-i obtained through the respective sample machining step 120s-i.

In further examples, the application software component 106 and/or the processor 102 may further be configured to determine a respective step volume 124-i corresponding to the respective sample start part lwf-i of the respective sample machining step 120s-i changed by the respective step tool volume 122-i.

The respective step volume 124-i may, e.g., be obtained by changing the respective sample start part lwf-i by the respective step tool volume 122-i. Hence, respective step volume 124-i may, in some examples, correspond to the respective sample end part mwf-i or the volume of the respective sample end part mwf-i of the respective sample machining step 120s-i.

In some examples, the respective step volume 124-i of the respective sample machining step 120s-i may also take into account the changes made to the respective sample start part lwf-i during the previous sample machining step(s) 120s-i. The respective step tool volume 122-i of the respective sample machining step 120s-i may, in some examples, also take into account the changes made to the respective sample start part lwf-i during the previous sample machining step(s) 120s-i. For example, the respective step tool volumes 122-i of two different sample machining steps 120s-i may overlap or may be related to each other. Hence, the respective step volume 124-i of the respective sample machining step 120s-i may, e.g., reflect a relation of one sample machining step 120s-i to another sample machining step 120s-i of the sample machining process 120s.

By way of example, the application software component 106 and/or the processor 102 may further be configured to determine at least one respective step feature 126 corresponding to the respective step volume 124-i.

By way of example, the respective step feature 126 may be understood as a region of a part with some interesting geometric or topological properties, sometimes called form features. Form features may contain both shape information and parametric information of a region of interest. Examples of form features are extruded boss, loft, etc. Further, the respective step feature 126 may be understood as a manufacturing feature. Hence, for example, one may either use the name “pocket” to refer to a swept cut on the boundary of a part model, or to refer to a trace left on the part boundary by a specific machining operation. The former is exclusively concerned with a geometric shape whereas the latter is concerned with both the geometric shape and a manufacturing operation, needing more parameters in its definition. As such, a manufacturing feature may, e.g., be minimally defined as a form feature (if it has a form that may uniquely represent it), but not necessarily vice versa (forms may be interpreted differently in different manufacturing domains). Machining features may be an important subset of manufacturing features. A machining feature may, e.g., be regarded as the volume swept by a “cutting” tool, that may regularly be a negative (subtracted) volume. Further a machining feature may, e.g., be regarded as the volume added by a “printing” tool, that may regularly be a positive (added) volume. Finally, there is also the concept of assembly feature, that encodes the assembly method between connected components. In some examples, the respective step feature 126 may be understood as the smallest set of phases that make sense from a manufacturing point of view.

Various Automatic Feature Recognition (AFR) techniques have been proposed for CAD/CAM integration and process planning, cf. e.g., https://en.wikipedia.org/wiki/Feature_recognition. For example, the CAM software NX CAM of Siemens Industry Software Inc., of Plano, Texas, USA provides feature recognition functionalities, cf. e.g., https://www.youtube.com/watch?v=r2Q3veZV8kk (“FBM Video Series-On Manufacturing Feature Recognition in NX CAM”; FBM stands for feature-based machining). As already mentioned above, other CAM systems, e.g., of Dassault Systèmes SE, of Vélizy-villacoublay, France, may have similar functionalities, including feature recognition functionalities.

Hence, in some examples, the respective step feature 126 may be determined by the CAM system 118, such as the NX CAM software, using the respective step volume 124-i as input. For the determination of the respective step feature 126, machining knowledge or pragmatics may, in some examples, be used. For example, if the respective sample machining step 120s-i is a drilling step with a drilling tool 142-i with a certain diameter, then one may, e.g., conclude that the respective step feature 126 may be or relate to a drill hole and/or that the feature diameter corresponds to the drilling tool diameter. Such machining knowledge or pragmatics may, by way of example, also be available through the CAM system 118.

Further, in some examples, the respective step feature 126 may be generalized, e.g., by substituting specific geometric dimensions with more generalized geometric parameters. Specific geometric dimensions may, e.g., be a specific length of 8 mm, a specific area of a circle with a diameter of 8 mm, or cubic volume with a side length of 8 mm. The corresponding generalized geometric parameters may, e.g., be a length L, a circle area with diameter D, or a cubic volume with side length L. Generalizing the respective step feature 126 may, in some examples, contribute to facilitate determining a later machining process 120 of a workpiece 140 by reusing the respective step feature 126. Assuming that the workpiece 140 includes a milled circular surface with a diameter of 10 mm, the generalized step feature 126 relating to a circle area with diameter D may readily be reused to determine the corresponding machining step 120-i of the machining process 120 to obtain the workpiece 140 from a blank 140. Hence, the respective generalized step feature 126 may, e.g., allow to facilitate determining a machining process 120 including machining steps 120-i or step features 126 that are similar to the specific geometric dimensions of the respective step feature 126, but not exactly the same as the specific geometric dimensions of the respective step feature 126.

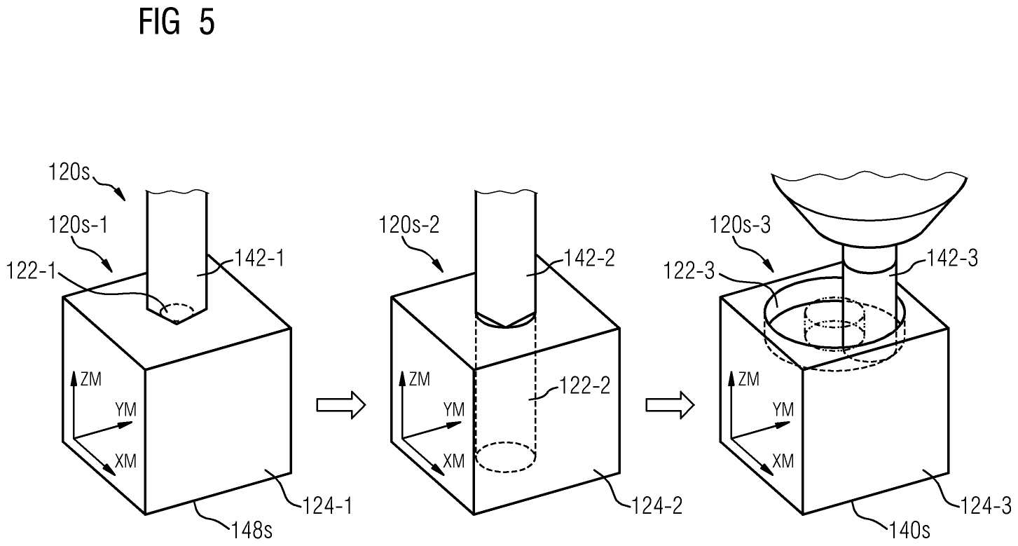

The suggested approach may, e.g., be applied to intermediate shapes that may be generated in a machining process 120 including several machining steps 120-i. This is, e.g., the case if there are at least two machining steps 120-i. Hereby, the intermediate shape may correspond to the respective sample end part mwf-i of a given machining step 120s-i. For example, for a given sample machining process 120s consisting of ten sample machining steps 120-1, . . . , 120-10, up to ten different step features 126 may be determined using the suggested approach. Other approaches may only take into account the final results of the sample machining process 120s so that only one step feature 126 might be determined. For illustration purposes, a counterbore hole machining process may be considered as the sample machining process 120s, whereby this sample machining process 120 may include two drilling machining steps 120s-1 and 120s-2 and a subsequent milling machining step 120s-3 (cf. e.g. FIGS. 5 to 7). According to the suggested approach, up to three step features 126 may be determined that relate to the two intermediate shapes or sample end parts mwf-i and the finally obtained sample workpiece 140s, whereas according to other approaches, only one step feature 126 may be determined that relates to the finally obtained sample workpiece 140s.

Correspondingly, the rules or step features 126 resulting from the suggested approach may be applied to a larger variety of workpieces 140 or machining steps 120 since they relate to various drilling and milling machining steps 120-i relating to drill holes or counterbore holes, whereas the rules or step features 126 resulting from the other approaches may only be applied to counterbore holes, but not to intermediate shapes that might occur individually elsewhere in the workpiece 140.

Hence, the suggested approach, e.g., allows to generate atomic re-usable rules or step features 126 that may enable to manage the combinatorial explosion that may exist due the many possible combination of single features or machining steps 120i when machining a workpiece. Using other approaches, the mentioned combinatorial explosion may regularly not be manageable anymore that may necessitate more user input.

In further examples, the application software component 106 and/or the processor 102 may further be configured to store the respective step feature 126 in a machining information database 128.

The machining information database 128 may, in some examples, be included by the data processing system 100, the CAM system 118, or the machine tool 144. In further examples, the machining information database 128 may be stored in the cloud or a computing facility that is available over the internet. Storing the respective step feature 126 in the machining information database 128 may allow to access and reuse the respective step feature 126 for machining other workpieces 140, e.g., using other CAM systems 118 or other machine tools 144.

In an example embodiment, the respective step feature 126 may include at least one of a feature type, a feature parameter, a feature geometric dimension, a feature machining area, a feature tool class, a feature geometric tool dimension, a feature operation type, a feature tolerance specification, information on at least one condition when the respective step feature 126 may be applied, at least one dependency on at least one previous machining step 120-i or at least one other step feature 126, or any combination thereof.

In some examples, the feature type may include pockets, holes, step pockets, step holes, corner notches, side notches, and the like. Further, the feature parameter may, e.g., include the feature geometric dimension, the feature tolerance specification or boundaries or ranges of the feature geometric dimension or the feature tolerance specification. The feature geometric dimension may, e.g., define the length, depth, width, area, volume, angle, curve, flatness, etc. of the respective step feature 126 or a part of the workpiece 140, e.g., the feature type. The feature machining area may, e.g., define a certain area, e.g., of the feature type that may be subject to a certain machining step 120-i. The feature tool class may, e.g., different classes of tools 142, such as drilling, milling, polishing, honing, or printing tools. The feature geometric tool dimension may, e.g., define the geometric size, such as length, area, diameter, volume, etc., of the respective tool 142-i used for the respective machining step 120-i. The feature operation type may, e.g., define the type of machining step, e.g., drilling, milling, polishing, honing or printing. The feature tolerance specification may, e.g., define the IT-grade of the respective step feature 126 or a part of the workpiece 140, e.g., the feature type, whereby the IT-grade is an internationally accepted code system for tolerances on linear dimensions. Further, the feature tolerance specification may, e.g., define the surface roughness or more generally information on geometric dimensioning and tolerancing (GD&T) of the respective step feature 126 or a part of the workpiece 140, e.g., the feature type. The feature tolerance specification may, e.g., also define product and manufacturing information (PMI) of the respective step feature 126 or a part of the work-piece 140, e.g., the feature type, whereby PMI may convey non-geometric attributes in three-dimensional (3D) CAD and collaborative product development systems necessary for manufacturing product components and assemblies. PMI may include geometric dimensions and tolerances, 3D annotation (e.g., text) and dimensions, surface finish, and material specifications.

In some examples, the respective step feature 126 may further include information on conditions when the step feature 126 may be applied and/or at least one dependency on at least one previous machining step 120-i or at least one other feature 126. For example, a drilling step may require a previous or preparatory spot drilling step 120-i−1 so that the drilling tool 142-i does not slip away on the surface of the workpiece 140 during the drilling step 120-i.

In some examples, the application software component 106 and/or the processor 102 may further be configured to determine at least one common aspect of the respective step feature 126 of the respective sample machining step 120s-i and of the respective step feature 126 of the respective subsequent sample machining step 120s-i+1; and to store information on the respective common aspect together with the respective step feature 126 of the respective subsequent sample machining step 120s-i in the machining information database 128.

Such a common aspect may, in some examples, relate to the same geometrical dimension that may be relevant to the respective step feature 126 of both the respective sample machining step 120s-i and of the respective subsequent sample machining step 120s-i+1. To determine the respective common aspect, in some examples, the respective step feature 126 of the of the respective sample machining step 120s-i may be compared with the respective step feature 126 of the respective subsequent sample machining step 120s-i+1, wherein identical or the same aspects included by the two respective step features 126 may be identified to be such a common aspect. Herein, the comparison may be done sequentially, e.g., aspect after aspect of the one respective step feature 126 may be compared with aspect after aspect of the other respective step feature 126. For example, returning to the above counterbore hole machining process used for illustration purposes that may include two drilling machining steps 120s-1 and 120s-2 and a subsequent milling machining step 120s-3: the second drilling machining step 120s-2 may be a simple hole with the diameter D1 and the smaller diameter of the counterbore hole D2 machined during the subsequent milling machining step 120s-3 may be equal to the diameter D1 of the simple hole. Hence, the common aspect of the second drilling machining step 120s-2 and the subsequent milling machining step 120s-3 may be the diameter D1 or D2 that is both the diameter of the simple hole and the smaller diameter of the counterbore hole.

In some examples, the described common aspect may indicate or characterize a dependency of the respective sample machining step 120s-i or of the respective step feature 126 on at least one previous machining step 120-i or at least one other feature 126.

In some examples, the described common aspect may relate to a respective step feature 126 of two or more respective sample machining steps 120s-i. Further, these respective sample machining steps 120s-i may directly follow each other, or one or more intermediate sample machining steps 120-i may be carried out between these respective sample machining steps 120s-i including a common aspect.

By way of example, the application software component 106 and/or the processor 102 may further be configured to provide a machining rule set characterizing the respective machining step 120s-i performable with the respective tool 142-i; and to segment the sample machining process 120s into the respective consecutive sample machining steps 120s-i using the machining rule set.

The machining rule set may, for example, include information on various available tools 142 and which respective machining step 120-i may be performed with the respective tool 142. The machining rule set may, for example, further include the tolerances, such as roughness or other information on geometric dimensioning and tolerancing, that may be achievable with the respective tool 142. By way of example, the machining rule set may further include information on prerequisites for the respective machining step 120-i, e.g., a required surface quality, such as a small roughness value, to perform a polishing step.

Using the machining rule set, a sample machining process 120s for machining a sample workpiece 140s from a sample blank 148s may be segmented into individual, consecutive sample machining steps 120s-i. In some examples, the machining rule set may be provided or stored in the CAM system 118 and/or in the machining information database 128.

In some examples, the order of determining the sequence of sample machining steps 120s-i of the sample machining process 120s may be reversed with respect to the order of the real sample machining process 120s. Hence, first, the last sample machining step 120s-last may be determined using the machined sample workpiece 140s as sample end part mwf-last by applying the machining rule set and obtaining the sample start part lwf-last. Then, the penultimate sample machining step 120-s-penult may be determined using the sample start part lwf-last of the last sample machining step 120s-last as sample end part mwf-penult by applying the machining rule set and obtaining the sample start part lwf-penult, and so on until the sample blank 148s is obtained for the first sample machining step 120s-1. this approach may, e.g., be considered as a rule-based algorithm contrary to a data-based algorithm. This rule-based approach may have a well-defined purpose and may search for solutions of a well-defined problem that may also be known as “generative machining”. While this rule-based algorithm may regularly solve the problem and determine the sample machining process 120s and the included sample machining steps 120-i, other, data-based algorithms may fail due to the above-mentioned combinatorial explosion that may exist due the many possible combinations of single step features 126 or machining steps 120-i when machining a workpiece 140.

In some examples of machining a workpiece 140, the machining rule set may further be used to determine the machining process 120 or segment the machining process 120 into the respective consecutive sample machining steps 120s-i.

In some examples, the application software component 106 and/or the processor 102 may further be configured to determine the respective step feature 126 using the machining rule set.

The above-described machining rule set may include valuable information that may allow, e.g., together with the respective step volume 124-i and optionally the respective machining step 120s-i or another aspect of the respective step feature 126, to derive the respective step feature 126. For example, the feature geometric dimension or the feature geometric tool dimension may be searched as respective step feature 126 and the following information may be available: In a first example, the class of the tool 142 may be a twist drill, the feature class may be a simple through hole and the used tool 142 may have a diameter of 12 mm. Then the searched feature geometric dimension may be deduced to be a diameter 12 mm. The tool diameter may hence equal the searched feature geometric dimension. In a second example, the tool class may be end mill and the feature class of the start part lwf may be a simple through hole, the end part mwf may be a counterbored hole, the used tool 142 may have a diameter of 10 mm, the step feature may have a hole diameter of 12 mm, and the step machining area may be the counterbore diameter. We may then infer on the feature geometric tool dimension that the tool diameter is smaller than the diameter of the end part mwf and that the length of the flute of the tool 142 is larger than the depth of the end part mwf.

As depicted by these two examples, using the machining rule set and optionally one or more aspects of the respective step feature 126, a (further) aspect of the respective step feature 126 may be determined or logically be deduced.

In further examples, the application software component 106 and/or the processor 102 may further be configured to determine that the respective step feature 126 corresponds to an older respective step feature 126_old that is already stored in the machining information database 128; to display a user interface (UI) element 138 indicating that the respective step feature 126 corresponds to an older respective step feature 126_old that is already stored in the machining information database 128 to the user via a computer-aided manufacturing user interface (CAM UI) 116; to capture the user's intent to store the respective step feature 126 in the machining information database 128, to replace the older respective step feature 126_old in the machining information database 128 with the respective step feature 126, or to dismiss the respective step feature 126 in response to user interactions with the CAM UI 116; and to store the respective step feature 126 in the machining information database 128, replacing the older respective step feature 126_old in the machining information database 128 with the respective step feature 126, or dismissing the respective step feature 126 according to the captured user's intent.

In some examples, a specific step feature 126 may already be stored in the machining information database 128, e.g., the older step feature 126_old relating to a counterbore hole. If the above-described approach of determining the respective step feature 126 relates to a counterbore hole, both this more recent step feature 126 and the older step feature 126_old may be determined to correspond to each other. The determination that the step feature 126 and the older step feature 126_old correspond to each other may, e.g., be done by a one-to-one comparison of the step feature 126 with the already stored older step feature(s) 126_old or, e.g., by using a lookup table or categories of step features 126 to which the respective step feature 126_fits and that may then be searched for older step features 126_old. Hereby, this correspondence may, e.g., mean that the older respective step feature 126_old and the respective (more recent) step feature 126 may be identical or at least similar to each other. If such a correspondence has been determined, information on this correspondence may be displayed to the user using the UI element 138 that may be displayed in the CAM UI 116. The user may then be given one or more options on how to proceed, e.g., storing the respective step feature 126 and the machining information database, especially if the respective step feature 126 and the older respective step feature 126_old are not identical. Another option may be to replace the older respective step feature 126_old with the respective step feature 126, and yet another option may be to ignore or dismiss the respective step feature 126 and, e.g., simply keep the older respective step feature 126_old. The user may provide his or her input, e.g., by interacting with the CAM UI 116, whereby the option chosen by the user may then be implemented.

This interactive way of handling similar or identical step features 126 may still provide full control to users while simplifying and enhancing the management of step features 126 and hence of machining information. In some examples, default options may be displayed to the user, thereby further simplifying the management of the step features 126, especially for non-expert users. Such a default option may, e.g., relate to similar, but not identical step features 126 for which the additional storage of the (more recent) respective step feature 126 in the machining information database 128 may be suggested. Another default option may, e.g., relate to identical step features 126 for which the dismissal of the respective step feature 126 without storing the respective step feature 126 in the machining information database 128 may be suggested. In both cases, the user may then simply confirm the suggested default option unless the user prefers one of the other available options.

In some examples, the application software component 106 and/or the processor 102 may further be configured to determine that the respective step feature 126 is identical to an older respective step feature 126_old that is already stored in the machining information database 128; and dismissing the respective step feature 126 without storing the respective step feature 126 in the machining information database 128

In the context of the above-explained on the older respective step feature 126_old, if the (more recent) respective step feature 126 is identical to the older respective step feature 126_old, the (more recent) respective step feature 126 may, in some examples, be dismissed or ignored without further activities, such as user interaction or storage in the machining information database 128.

This automated way of handling identical step features 126 may simplify and enhance the management of step features 126 and hence of machining information by directing the user's attention to cases that may require his or her input and by automatically handling rather clear cases that do not require the user's input.

In further embodiments, the determination of the respective step feature 126 and optionally the storage of the respective step feature 126 in the machining information database 128 may be performed for at least two different sample machining processes 120s for machining at least two different sample workpieces 140s.

In some examples, the determination of the respective step feature 126 may be done for a plurality of sample machining processes 120s that may relate to the machining of a plurality of sample workpieces 140s. Performing the mentioned determination for at least two, preferably many cases may contribute to establish a valuable and comprehensive knowledge database of respective step features embodied in the machining information database 128.

By way of example, the application software component 106 and/or the processor 102 may further be configured to provide a start shape of a blank 148 and target shape of the workpiece 140 to be machined from the blank 148; to determine a machining process 120 for machining the workpiece 140 using the respective step feature 126 stored in the machining information database 128; and to machine the workpiece 140 with the tool 142 according to the determined machining process 120.

Once the start shape of a blank 148 and target shape of the workpiece 140 to be machined from the blank 148 have been provided, the corresponding machining process 120 may be determined. This machining process 120 may include one machining step 120-1 or more consecutive machining steps 120-i. Further, in some examples, this machining process 120 may be determined by the CAM system 118 that may, e.g., include the above-mentioned Automatic Feature Recognition (AFR) techniques for CAD/CAM integration and process planning, e.g., the “Create Feature Process” of NX CAM of Siemens Industry Software Inc., of Plano, Texas, USA. Hereby, the machining process 120 may include at least two consecutive machining steps 120-i, whereby the respective step feature 126 stored in the machining information database 128 may be used for the determination of the machining process 120. The workpiece 140 may then be machined with the tool 142 according to the determined machining process 120.

In some examples, the machining steps 120-i for machining the workpiece 140 may be determined by applying the respective step feature 126 stored in the machining information database 128 in reversed order with respect to the order of the machining steps 120-i. Hence, the process of determining of the machining process 120 may start with determining the last machining step 120-last, then determining the penultimate machining step 120-penult, . . . , until determining the first machining step 120-i that applied to the blank 148, whereby the respective step feature 126 may be used for the respective determination.

As depicted in FIG. 1, the CAM system 118 may be communicatively connected with the machine tool 144 that includes the control device 146 and the tool 142. The CAM system 118 may, in some examples, transmit a machine code corresponding to the machining process 120 to the machine tool 144 or the control device 146. The machine tool 144 may then machine the blank 148 according to the machining process 120, e.g., along a certain toolpath, to obtain the machined workpiece 140. The machine tool 144 may, e.g., move the tool 142 (relatively to the workpiece 140) along the toolpath to machine the workpiece 140 according to the machining process 120 from the blank 148.

Further, as depicted in FIG. 1, the CAM system 118 may include the machining information database 128 that may correspond to the data store 108. The sample machining process 120s, the respective step tool volume 122, the respective step volume 124 and the respective step feature 126 may be stored in the data store 108.

According to the suggested approach, generic machining rules, e.g., the respective step feature 126, may be synthesized by learning from an actual process, such as the sample machining process 120s, programmed in a CAM system 118, such as NX CAM of Siemens Industry Software Inc., of Plano, Texas, USA. The learning step may, e.g., produce the elementary rules, e.g., the respective step feature 126.

According to other approaches, the elementary rules, e.g., the respective step feature 126, need to be synthesized or defined by a trained user. Further, according to other approaches, users may use Teach Operation Sets but that will not give them generic re-usable rules for geometries other than the ones they were taught on. Such Teach Operation Set requires the user to supply the tool queries and application conditions manually. These other approaches ignore any geometry transformations and that is why user must teach each final geometry and each variation individually.

For the example of a counterbored hole as a sample machining process 120s, the novelty and the advantage of the suggested approach may be that the learned machining rules, e.g., the respective step feature 126, may also solve machining features that were stages, e.g., intermediate parts, in the solution of the counterbored hole. Since machining a counterbored hole may require machining a simple through hole first, the respective step feature 126 of a simple through hole may be determined and stored in the machining information database 128. Then, if a simple through hole is recognized in another or the same part geometry, e.g., the workpiece 140, we have the machining rule, the respective step feature 126 of a simple through hole, from learning how a counterbored hole is done.

By way of example, the suggested approach may have the following benefits over other approaches: The combinatorial explosion may quickly become unmanageable when using existing Teach Operation Sets of other approaches. The suggested approach, however, may open the way to generate atomic re-usable rules, e.g., the respective step feature 126, so that this problem may be avoided. The suggested approach may help to reduce the need of in-depth expertise to synthesize generic machining rules, e.g., the respective step feature 126. For example, according to other approaches, expert knowledge may be necessary to handle the “Machining Knowledge Editor” of NX CAM of Siemens Industry Software Inc., of Plano, Texas, USA or of similar tools of that may allow to customize and create your own machining knowledge rules, e.g., the respective step feature 126, for use throughout all programs or machining processes for other workpieces that you will create in the future. The suggested approach may reduce the size of the machining knowledge and with that keeping it maintainable by avoiding duplication within the machining knowledge.

The described application software component 106 and/or the processor 102 may carry out an analogous method of facilitates managing machining information, for example determining step features 126 from a sample machining process 120s.

Further, a computer-readable medium 160 that may include a computer program product 162 is shown in FIG. 1, wherein the computer program product 162 may be encoded with executable instructions, that when executed, causes the computer system 100 or and/or the CAM system 118 (or optionally the machine tool 144) to carry out the described method.

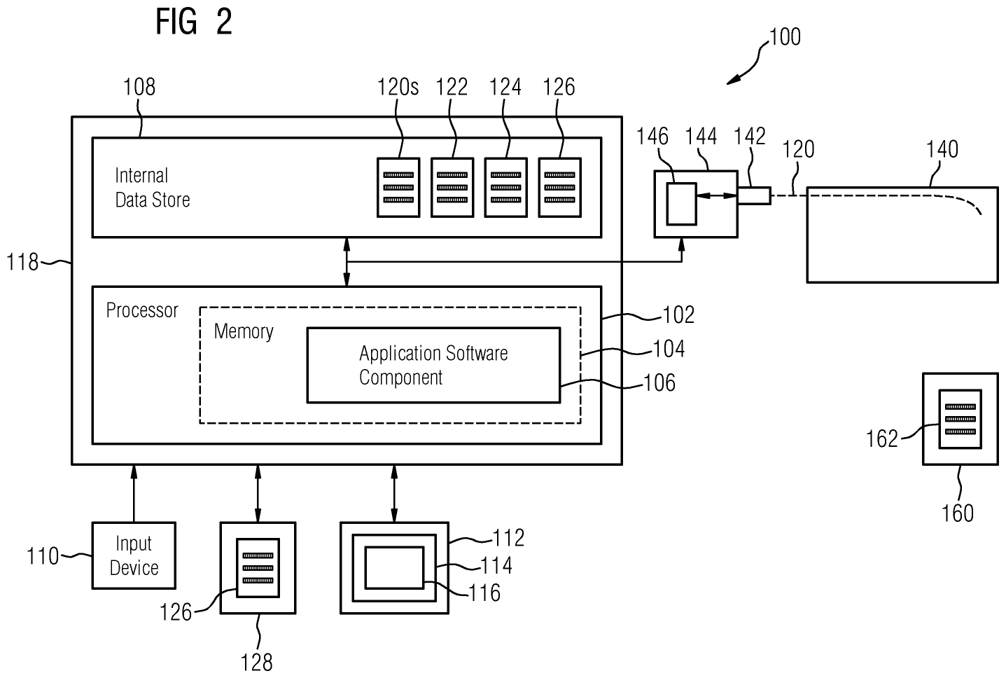

With reference to FIG. 2, a functional block diagram of another example product system or data processing system 100 is depicted that facilitates managing machining information, for example determining step features 126 from a sample machining process 120s.

As depicted in FIG. 2, the CAM system 118 may include the data store 108 in which the sample machining process 120s, the respective step tool volume 122, the respective step volume 124 and the respective step feature 126 may be stored. The data processing system 100 may further include the machining information database 128 that may be separate from the data store 108 of the CAM system 118 and from the CAM system 118, respectively. The machining information database 128 may be communicatively coupled with the CAM system 118. The respective step feature 126 may further be stored in the machining information database 128 that, in some examples, may be stored in the cloud or a computing facility that is available over the internet.

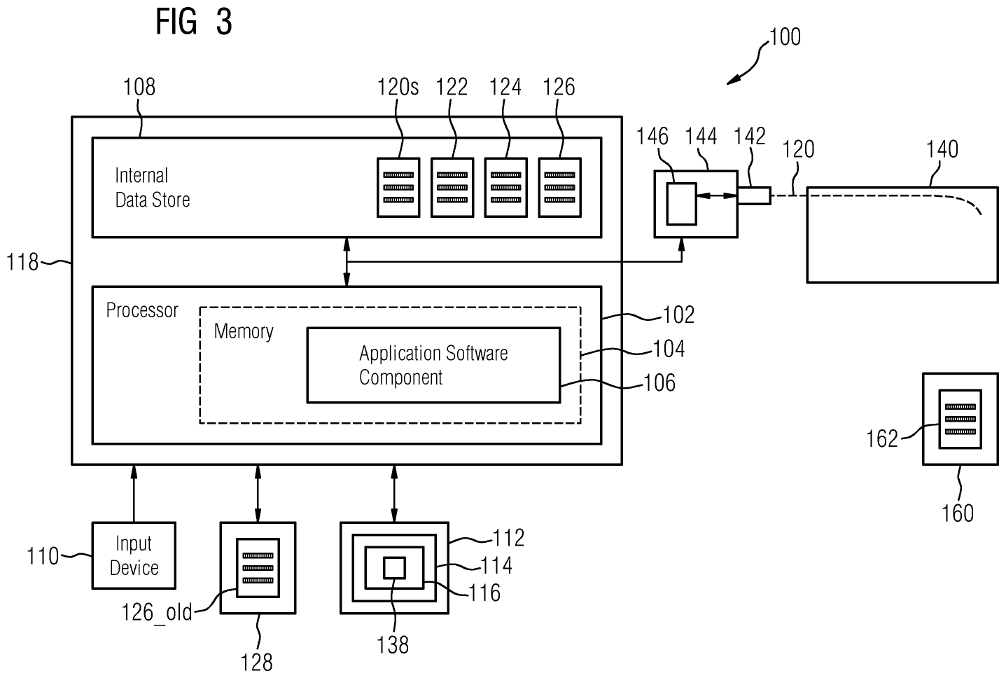

With reference to FIG. 3, a functional block diagram of a further example product system or data processing system 100 is depicted that facilitates managing machining information, for example determining step features 126 from a sample machining process 120s.

In some examples, the respective step feature 126 may correspond to an older respective step feature 126_old that is already stored in the machining information database 128. In such cases, a UI element 138 may be displayed to the user via the CAM UI 116 indicating the determined correspondence. The user may then provide his or her input on how to proceed, e.g., by interacting with the CAM UI 116, whereby the user's input intent may be captured. E.g., the user may want to store the respective step feature 126 in the machining information database 128, to replace the older respective step feature 126_old in the machining information database 128 with the respective step feature 126, or to dismiss the respective step feature 126. The captured user's intent may then be implemented accordingly.

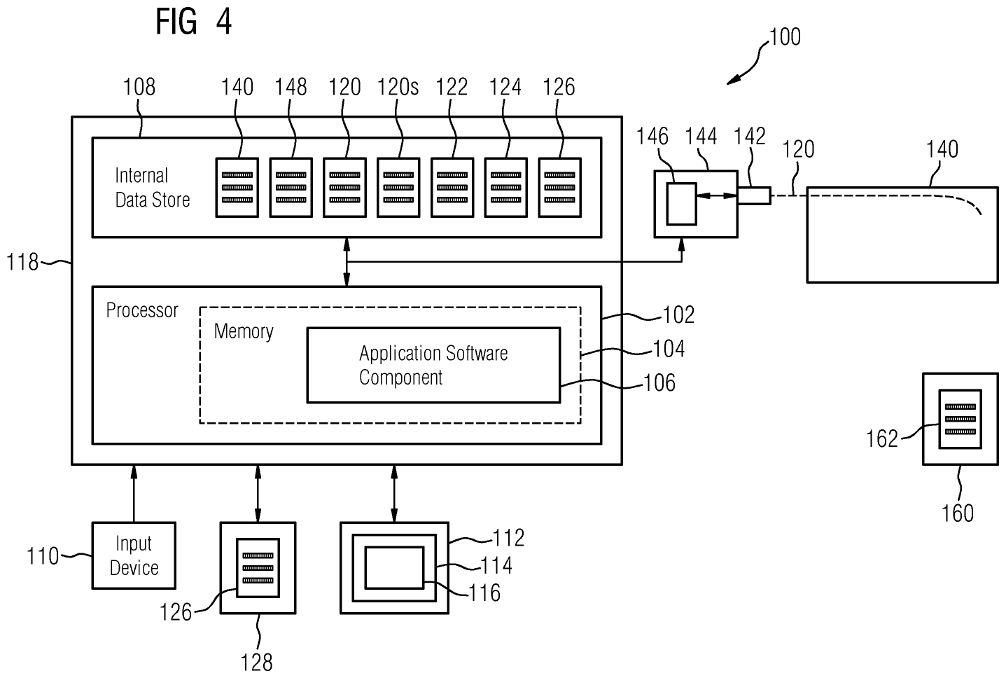

With reference to FIG. 4, a functional block diagram of yet another example product system or data processing system 100 is depicted that facilitates managing machining information, for example determining step features 126 from a sample machining process 120s.

According to this example, the user may provide a start shape of a blank 148 and target shape of the workpiece 140 that is to be machined from the blank 148. The CAM system may then determine the machining process 120 for machining the workpiece 140 from the blank 148, wherein the machining process 120 may include one machining step 120-1 or more consecutive machining steps 120-i, and whereby for the determination of the machining process 120 the respective step feature 126 stored in the machining information database 128 is used. The workpiece 140 may then be machined with the tool 142 of the machine tool 144 that is controlled by a controller 146 according to the determined machining process 120.

With reference to FIGS. 5 to 7, flow diagrams of an example methodology that facilitates managing is depicted that facilitates managing machining information, for example determining step features 126 from a sample machining process 120s, and sample step features 126, in a product system or data processing system 100, are depicted.

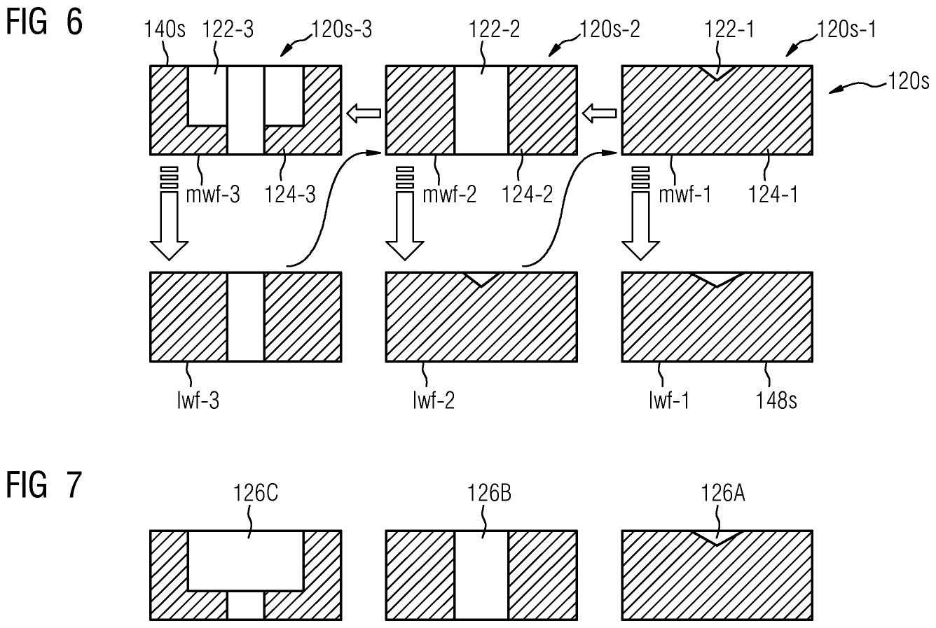

As depicted in FIGS. 5 and 6, the sample machining process 120s includes the three machining steps 120s-1, 120s-2, and 120s-3 for machining a sample workpiece 140s from the sample blank 148s with a respective tool 142-1, 142-2, and 142-3. In the first machining step 120s-1, a spot is drilled in the sample blank 148s (that is the sample start part lwf-1) with a corresponding drilling tool 142-1. Hereby, the drilled volume may correspond to the step tool volume 122-1 and the volume of the resulting sample end part mwf-1 may correspond to the step volume 124-1 from which the step feature 126-A (“Location Point”, also depicted in FIG. 7) may be determined. In the second machining step 120s-2, a simple through hole is drilled in the sample start part lwf-2 (that also is the sample end part lwf-1) with a corresponding drilling tool 142-2. Hereby, the drilled volume may correspond to the step tool volume 122-2 and the volume of the resulting sample end part mwf-2 may correspond to the step volume 124-2 from which the step feature 126-B (“Simple through hole”, also depicted in FIG. 7) may be determined. In the third machining step 120s-3, a counterbore is milled in the sample start part lwf-3 (that also is the sample end part lwf-2) with a corresponding milling tool 142-3. Hereby, the milled volume may correspond to the step tool volume 122-3 and the volume of the resulting sample end part mwf-3 may correspond to the step volume 124-3 from which the step feature 126-C (“Counterbore hole”, also depicted in FIG. 7) may be determined.

As indicated in FIG. 6 with the arrows between the respective sample start part lwf-i and the respective sample end part mwf-i, the order of determining the sequence of sample machining steps 120s-i of the sample machining process 120s may, in some examples, be reversed with respect to the order of the real sample machining process 120s that is indicated with the arrows in FIG. 5 and in FIG. 6 between the respective sample end parts mwf-i.

The determined step features 126A, 126B, and 126C may then be stored in the machining information database 128.

Contrary to the suggested approach, other approaches may only be able to derive the step feature 126C “Counterbore hole” using the depicted three machining steps 120s-1, 120s-2, and 120s-3. Hence, according to these other approaches, only the step feature 126C “Counterbore hole” may then be applied to this (and potentially other) counterbore hole geometry(ies). However, no intermediate shape or step feature 126, e.g., the “Simple through hole” 126B, would be considered in these other approaches so that no intermediate shape or step feature 126 may be derived and then be applied if this intermediate shape or step feature 126 would occur individually elsewhere in a part of a workpiece 140.

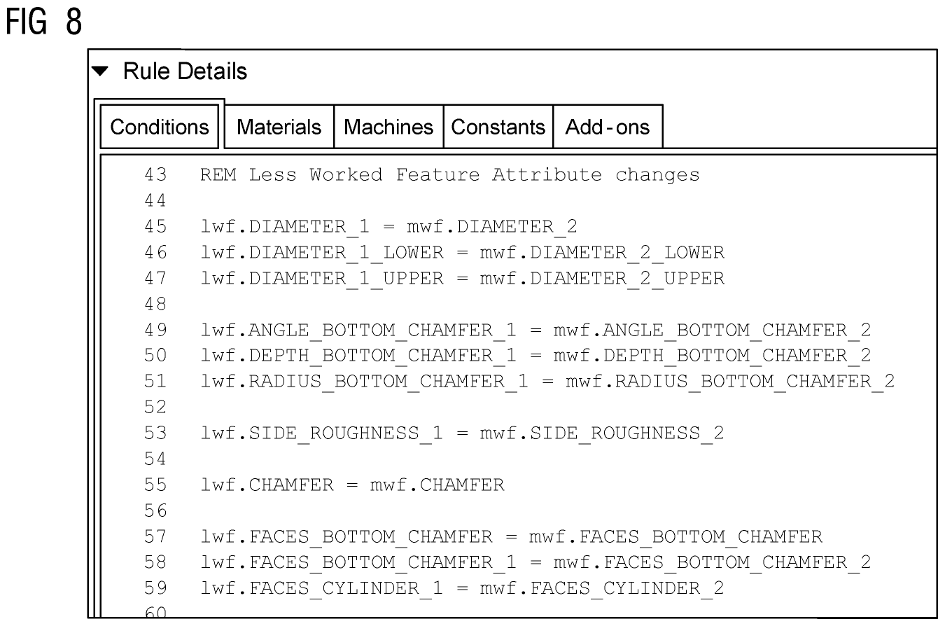

With reference to FIGS. 8 to 10, some sample rules relating to some determined sample step features 126 in a product system are depicted.

As depicted in FIG. 8, the respective step feature 126 may include expressions defining the dimensions of the preceding simple hole (lwf) in terms of the dimensions of the counterbore hole (mwf), of which examples are depicted in FIGS. 5 to 7 and explained above. For instance, “lwf.Diameter_1=mwf.Diameter_2” may be understood as: “the diameter of the simple hole is equal to the smaller diameter of the counterbore hole”.

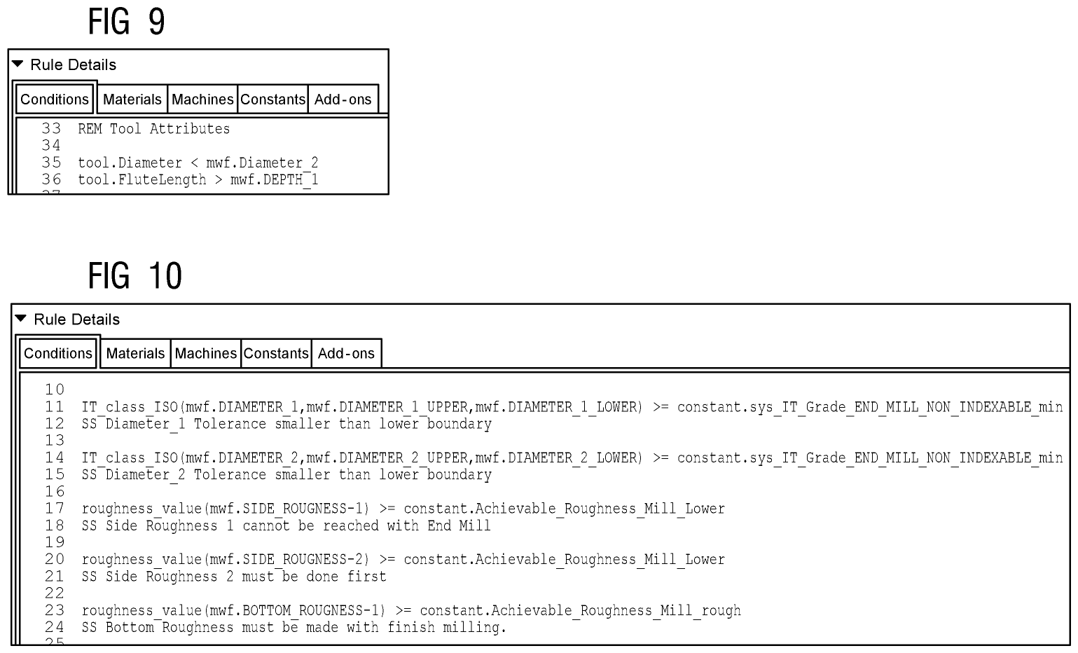

The respective step feature 126 depicted in FIG. 9, e.g., relating to the geometric tool dimension, may be determined in the following context: the tool class is End Mill, the less worked feature class is a simple through hole, the more worked feature class is a counterbored hole, the used tool has a diameter=10, the recognized feature has a hole diameter=12, and the machining area is the counterbore diameter.

The respective step feature 126 depicted in FIG. 10, e.g., relating to the feature tolerance specification, may be determined using a machining rule set that may reflect domain knowledge. The machining rule set may, e.g., include the information that tools 142 from a specific class may meet tolerance specifications in a specific bandwidth. The tolerance specifications may, e.g., include the IT-grade and the surface roughness. The machining rule set may be used to postulate generic constraints in the form of expressions as depicted in FIG. 10. The bandwidths boundaries may be determined by what sometimes may be called constants. The values of the constants may be derived from the results of standard NX CAM feature recognition that may read PMI data.

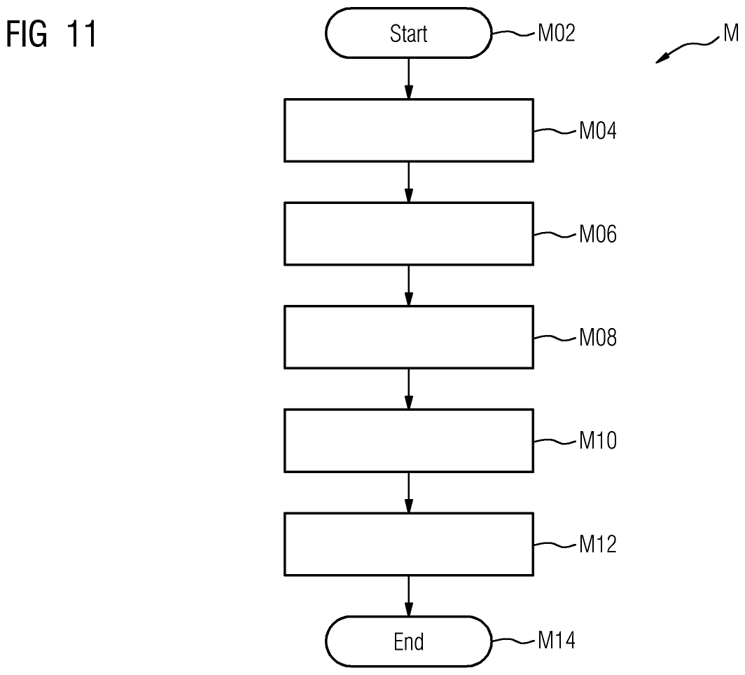

With reference to FIG. 11, a flow diagram of another example methodology M that facilitates managing machining information, for example determining step features from a sample machining process, in a product system or data processing system is depicted. Herein, the machining information may be used for machining a workpiece with a respective tool that is included by a machine tool. The method may start at M02, and the methodology may include several acts, e.g., carried out through operation of the processor, or the machine tool. These acts may include an act M04 of providing a sample machining process for machining a sample workpiece from a sample blank, the sample machining process including at least two consecutive sample machining steps performed by the respective tool starting with a respective sample start part and ending with a respective sample end part, wherein the respective sample end part of the respective sample machining step is the respective sample start part of the respective subsequent sample machining step; an act M06 of determining a respective step tool volume corresponding to a movement of the respective tool during the respective sample machining step; an act M08 of determining a respective step volume corresponding to the respective sample start part of the respective sample machining step changed by the respective step tool volume; an act M10 of determining at least one respective step feature corresponding to the respective step volume; and an act M12 of storing the respective step feature in a machining information database. At M14 the methodology may end.

The methodology M may include other acts and features discussed previously with respect to the processing system 100 or the computer-implemented method.

The above examples are equally applicable to the processor, the control device, the machine tool or the computer system, and to the corresponding computer-readable medium and the computer program product explained in the present patent document, respectively.

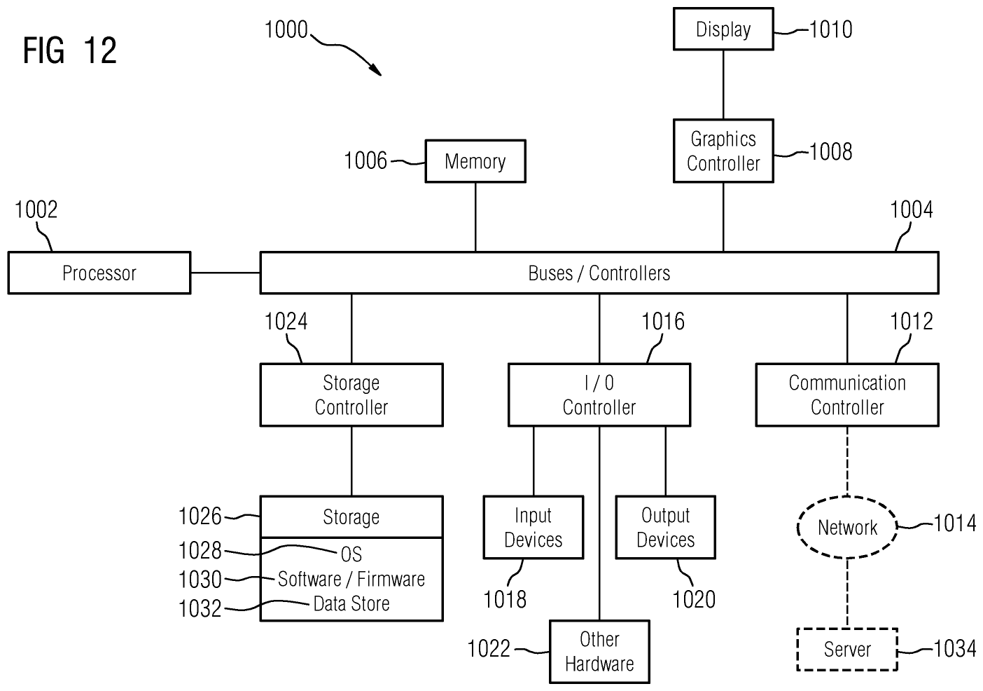

FIG. 12 depicts a block diagram of a data processing system 1000 (also referred to as a computer system) in which an embodiment may be implemented, for example, as a portion of a product system, and/or other system operatively configured by software or otherwise to perform the processes as described herein. The data processing system 1000 may include, for example, the computer or IT system or data processing system 100 mentioned above. The data processing system depicted includes at least one processor 1002 (e.g., a CPU) that may be connected to one or more bridges/controllers/buses 1004 (e.g., a north bridge, a south bridge). One of the buses 1004, for example, may include one or more I/O buses such as a PCI Express bus. Also connected to various buses in the depicted example may include a main memory 1006 (RAM) and a graphics controller 1008. The graphics controller 1008 may be connected to one or more display devices 1010. It should also be noted that in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 1012 (Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may include one or more I/O controllers 1016 such as USB controllers, Bluetooth controllers, and/or dedicated audio controllers (connected to speakers and/or microphones). Various peripherals may be connected to the I/O controller(s) (via various ports and connections) including input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers) or any other type of device that is operative to provide inputs to or receive outputs from the data processing system. Also, many devices referred to as input devices or output devices may both provide inputs and receive outputs of communications with the data processing system. For example, the processor 1002 may be integrated into a housing (such as a tablet) that includes a touch screen that serves as both an input and display device. Further, some input devices (such as a laptop) may include a plurality of different types of input devices (e.g., touch screen, touch pad, keyboard). Also, other peripheral hardware 1022 connected to the I/O controllers 1016 may include any type of device, machine, or component that is configured to communicate with a data processing system.

Additional components connected to various busses may include one or more storage controllers 1024 (e.g., SATA). A storage controller may be connected to a storage device 1026 such as one or more storage drives and/or any associated removable media, that may be any suitable non-transitory machine usable or machine-readable storage medium. Examples include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may include an operating system 1028, software/firmware 1030, and data stores 1032 (that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data, that is retrievable by a processor.

The communication controllers 1012 may be connected to the network 1014 (not a part of data processing system 1000), that may be any public or private data processing system network or combination of networks, as known to those of skill in the art, including the Internet. Data processing system 1000 may communicate over the network 1014 with one or more other data processing systems such as a server 1034 (also not part of the data processing system 1000). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely.

In addition, data processing systems may be implemented as virtual machines in a virtual machine architecture or cloud environment. For example, the processor 1002 and associated components may correspond to a virtual machine executing in a virtual machine environment of one or more servers. Examples of virtual machine architectures include VMware ESCi, Microsoft Hyper-V, Xen, and KVM.

The hardware depicted for the data processing system may vary for particular implementations. For example, the data processing system 1000 in this example may correspond to a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, it should be noted that the processor described herein may be located in a server that is remote from the display and input devices described herein. In such an example, the described display device and input device may be included in a client device that communicates with the server (and/or a virtual machine executing on the server) through a wired or wireless network (that may include the Internet). In some embodiments, such a client device, for example, may execute a remote desktop application or may correspond to a portal device that carries out a remote desktop protocol with the server in order to send inputs from an input device to the server and receive visual information from the server to display through a display device.

Examples of such remote desktop protocols include Teradici's PCoIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, that may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, it should be understood that the words or phrases used herein should be construed broadly, unless expressly limited in some examples. For example, the terms “include” and “include,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather these numeral adjectives are used to distinguish different elements, functions or acts from each other. For example, a first element, function, or act could be termed a second element, function, or act, and, similarly, a second element, function, or act could be termed a first element, function, or act, without departing from the scope of the present disclosure.

In addition, phrases such as “processor is configured to” carry out one or more functions or processes, may mean the processor is operatively configured to or operably configured to carry out the functions or processes via software, firmware, and/or wired circuits. For example, a processor that is configured to carry out a function/process may correspond to a processor that is executing the software/firmware, that is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes, may also correspond to a processor circuit particularly fabricated or “wired” to carry out the functions or processes (e.g., an ASIC or FPGA design). Further the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may mean: that an element is relatively near to but not in contact with a further element; or that the element is in contact with the further portion, unless the context clearly indicates otherwise.

It is to be understood that the elements and features recited in the appended claims may be combined in different ways to produce new claims that likewise fall within the scope of the present embodiments. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present embodiments have been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of managing machining information for machining a workpiece with a respective tool that is comprised by a machine tool, the method comprising:
providing a sample machining process for machining a sample workpiece from a sample blank, the sample machining process comprising at least two consecutive sample machining steps performed by the respective tool starting with a respective sample start part and ending with a respective sample end part;
wherein the respective sample end part of the respective sample machining step is the respective sample start part of the respective subsequent sample machining step;
determining a respective step tool volume corresponding to a movement of the respective tool during the respective sample machining step, wherein the respective step tool volume corresponds to a difference in volume between the respective sample start part and the respective sample end part obtained through the respective sample machining step;
determining a respective step volume corresponding to the respective sample start part of the respective sample machining step changed by the respective step tool volume;
determining at least one respective step feature corresponding to the respective step volume; and
storing the respective step feature in a machining information database.

2. The computer-implemented method of claim 1, wherein the respective step feature comprises at least one of a feature type, a feature parameter, a feature geometric dimension, a feature machining area, a feature tool class, a feature geometric tool dimension, a feature operation type, a feature tolerance specification, information on at least one condition when the respective step feature may be applied, at least one dependency on at least one previous machining step or at least one other step feature, or any combination thereof.

3. The computer-implemented method of claim 1, further comprising:
determining at least one common aspect of the respective step feature of the respective sample machining step and of the respective step feature of the respective subsequent sample machining step; and
storing information on the respective common aspect together with the respective step feature of the respective subsequent sample machining step in the machining information database.

4. The computer-implemented method of claim 1, further comprising:
providing a machining rule set characterizing the respective machining step performable with the respective tool; and
segmenting the sample machining process into the respective consecutive sample machining steps using the machining rule set.

5. The computer-implemented method of claim 4, further comprising:
determining the respective step feature using the machining rule set.

6. The computer-implemented method of claim 1, further comprising:
determining that the respective step feature corresponds to an older respective step feature which is already stored in the machining information database;
displaying a user interface (UI) element indicating that the respective step feature corresponds to an older respective step feature which is already stored in the machining information database to the user via a computer-aided manufacturing user interface (CAM UI);
capturing the user's intent to store the respective step feature in the machining information database, to replace the older respective step feature in the machining information database with the respective step feature, or to dismiss the respective step feature in response to user interactions with the CAM UI; and
storing the respective step feature in the machining information database, replacing the older respective step feature in the machining information database with the respective step feature, or dismissing the respective step feature according to the captured user's intent.

7. The computer-implemented method of claim 1, further comprising:
determining that the respective step feature is identical to an older respective step feature which is already stored in the machining information database; and
dismissing the respective step feature without storing the respective step feature in the machining information database.

8. The computer-implemented method of claim 1, wherein the determination of the respective step feature and a storage of the respective step feature in the machining information database are performed for at least two different sample machining processes for machining at least two different sample workpieces.

9. The computer-implemented method of claim 1, further comprising:
providing a start shape of a blank and a target shape of the workpiece to be machined from the blank;
determining a machining process for machining the workpiece using the respective step feature stored in the machining information database; and
machining the workpiece with the tool according to the determined machining process.

10. A computer system for numerically controlling a machine tool that comprises a tool for machining a workpiece according to a machining process, wherein the computer system is arranged and configured to
provide a sample machining process for machining a sample workpiece from a sample blank, the sample machining process comprising at least two consecutive sample machining steps performed by the respective tool starting with a respective sample start part and ending with a respective sample end part;
wherein the respective sample end part of the respective sample machining step is the respective sample start part of the respective subsequent sample machining step;
determine a respective step tool volume corresponding to a movement of the respective tool during the respective sample machining step, wherein the respective step tool volume corresponds to a difference in volume between the respective sample start part and the respective sample end part obtained through the respective sample machining step;
determine a respective step volume corresponding to the respective sample start part of the respective sample machining step changed by the respective step tool volume;
determine at least one respective step feature corresponding to the respective step volume; and
store the respective step feature in a machining information database.

11. (canceled)

12. (canceled)

13. A non-transitory computer-readable medium that stores machine-readable instructions that, when executed by one or more processors, cause the one or more processors to:
provide a sample machining process for machining a sample workpiece from a sample blank, the sample machining process comprising at least two consecutive sample machining steps performed by a respective tool starting with a respective sample start part and ending with a respective sample end part;
wherein the respective sample end part of the respective sample machining step is the respective sample start part of the respective subsequent sample machining step;
determine a respective step tool volume corresponding to a movement of the respective tool during the respective sample machining step, wherein the respective step tool volume corresponds to a difference in volume between the respective sample start part and the respective sample end part obtained through the respective sample machining step;
determine a respective step volume corresponding to the respective sample start part of the respective sample machining step changed by the respective step tool volume;
determine at least one respective step feature corresponding to the respective step volume; and
store the respective step feature in a machining information database.
